(19) United States
(12) Patent Application Publication
(10) Pub. No.: US 2006/0140190 A1
(43) Pub. Date: Jun. 29, 2006

(54) Method and apparatus for configuring a communication path

(75) Inventor: Cheng-Yin Lee, Ottawa (CA)

Correspondence Address: ECKERT SEAMANS CHERIN & MELLOTT, LLC., US STEEL TOWER, 600 GRANT STREET, 44TH FLOOR, PITTSBURGH, PA, 15219-2788, US

(73) Assignee: ALCATEL, Paris (FR)

(21) Appl. No.: 11/020,503

(22) Filed: Dec. 23, 2004

(51) Int. Cl. H04L 12/56

(52) U.S. Cl. 370/395.3

(57) ABSTRACT

A method and apparatus for configuring a communication path which traverses different network domains are provided. A set-up signal for configuring the communication path is generated and includes both an identifier for identifying one or more network resources in one network domain and a domain identifier associated with the resource identifier which identifies the resource(s) as belonging to that network domain. The domain identifier allows resource identifiers unique to one domain to be included in an inter-domain communication path set-up signal. An inter-domain set-up signal may include a group identifier for identifying resources of a primary path in place of a specific identification of each resource.

### FIELD OF THE INVENTION

The present invention relates to methods and devices for configuring a communication path, and in particular but not limited to methods and devices for configuring a communication path which extends through different network domains.

### BACKGROUND OF THE INVENTION

In provisioning a communication path between two nodes on a network, a primary path is set up through the network to carry traffic between the two nodes under normal conditions. In addition, it is often desirable to establish a second path between the two nodes to carry traffic, for example, if the primary path fails or additional bandwidth is required. For this reason, the secondary path should try to avoid using the same resources (e.g. links and nodes) of the primary path so that the two paths are as diverse as possible. Although a network may provide a number of different resources that can be used to establish the secondary path, some resources may be exposed to the same or similar risk of failure as resources on the primary path, due, for example, to their geographical proximity. For example, different optical fibres connected to two different nodes may be bundled into the same pipe over part of their length and are therefore exposed to the same risk of failure if the pipe is severed. Links that share a common risk may be identified and assigned a group identity. For example, the RSVP-TE (Resource Reservation Protocol-Traffic Engineering) specification provides a “Shared Risk Link Group” (SRLG) identifier for use when setting up a protection path to avoid using resources exposed to the same risk (and therefore having the same SRLG identifiers) as the primary path.

Establishing a communication path between two nodes may require the path to traverse different network domains (or regions), e.g. networks that are managed under different administrations, (and which may also be referred to as Automated Systems (AS)) and where the SRLG IDs are not used consistently between the domains so that a group identifier in one domain has a different or no meaning in another domain. This may cause problems when setting up an interdomain communication path in that the use of SRLGs applicable to one domain in the set-up signalling cannot be correctly interpreted for the purpose of protection path set-up in another domain.

Another problem that may arise in set-up signalling is the amount of information that needs to be included in the signal specifying which resources to include or exclude when setting up the path. Furthermore, where the path traverses a number of different network domains, the set-up signalling includes details of resources in the different domains to include or exclude and it may be undesirable to pass information about the resources in one domain to another domain.

### SUMMARY OF THE INVENTION

According to one aspect of the present invention there is provided a method of forming a signal for configuring a communication path comprising: selecting at least one identifier used to identify one or more network resources in a predetermined network domain; and forming a signal for causing one or more network elements to configure a communication path including specifying in said signal the at least one identifier and a network domain identifier which indicates that the at least one identifier is associated with the network domain.

Advantageously, in this arrangement, the set-up signalling includes, in addition to an identifier for identifying one or more network resources, an area or domain identifier identifying the area with which the identifier is associated. This allows nodes in different areas to determine whether or not the identifier is applicable to that node.

The identifier may comprise an identifier used to identify a single resource on a network, for example a node (network element), communication path section, port, link or other resource. In another embodiment, the identifier may comprise a group identifier used to identify one or more resources in a predetermined network domain. For example, the group identifier may be used to identify a group of resources in a predetermined network domain in which the resources all have a common property. In one embodiment, the group identifier may comprise a shared risk link (SRLG) identifier.

In embodiments of the present invention, the set- up signal may include one or more group identifiers that pertain to different areas, together with an indication of the area with which each group identifier is associated.

In one embodiment, the method further comprises specifying in the signal, an indication that network resources in the domain having a group identifier should be either included or excluded in configuring the communication path.

According to another aspect of the present invention, there is provided a method of determining a communication path comprising the steps of: receiving a communication signal containing at least one identifier used to identify one or more network resources and an indication that said at least one group identifier is associated with a predetermined network domain; detecting the indication of said network domain in said signal; based on the detected network domain, determining whether to include said at least one identifier in a decision on determining said communication path; and determining said communication path.

In one embodiment, the identifier may comprise a group identifier used to identify one or more network resources, and the resources of the group may or may not all have a common property.

According to another aspect of the present invention, there is provided a method of determining a communication path section comprising: receiving at a network element a signal containing at least one identifier used to identify one or more network resources and an indication that the at least one identifier is associated with a predetermined network domain; and determining at the network element a communication path section based on whether or not the network element resides in the network domain indicated in the signal.

According to the present invention, there is provided a network element comprising signal forming means for forming, for transmission on a network, a signal for configuring a communication path, wherein said signal forming means is adapted to included in said signal at least one identifier used to identify one or more network resources in a predetermined network domain, and a network domain identifier indicating that said at least one identifier is associated with said network domain.

In one embodiment, the identifier may comprise an identifier for identifying any one or more resources in the predetermined network domain. The identifier may comprise a group identifier, and the resources in the group may or may not have a common property.

According to another aspect of the present invention, there is provided a network element comprising receiving means for receiving a communication signal containing at least one group identifier used to identify one or more network resources and an indication that the at least one identifier is associated with a predetermined network domain, detecting means for detecting the indication of the network domain in the signal, first determining means for determining, based on the detected network domain, whether to include the at least one identifier in a decision on configuring a communication path; and second determining means for determining said communication path.

In one embodiment, the second determining means is adapted to exclude from consideration in determining the communication path, network resources having any group identifiers associated with a detected network domain in the signal if the detected network domain is different from that in which the network element resides.

According to another aspect of the present invention, there is provided a network element comprising: receiving means for receiving a signal containing at least one identifier used to identify one or more network resources in a predetermined network domain, and an indication that said at least one identifier is associated with the predetermined network domain, and determining means for determining a communication path section based on whether or not the network element resides in the network domain indicated in said signal.

According to another aspect of the present invention, there is provided a method of forming a signal for transmission on a network, comprising receiving a resource group identifier used to identify a group of resources on a pre-configured network path, and forming a signal containing the resource group identifier.

Advantageously, the use of a resource group identifier to identify a group of resources on a pre- configured network path obviates the need to explicitly identify each individual resource in the signal, and therefore can take the place of individual identifiers for each resource and reduce the amount of space required in the signal to identify the resources of the group. Furthermore, the resource group identifier may constitute a pseudonym, alias or label to effectively mask or hide the identity of the resources in the group from third parties, where it is required or desirable to do so. For example, the resource group identifier can be used to prevent information about specific resources in one domain (or automated system) being revealed to another domain, and this may be particularly useful in path set-up signals used to set-up communication paths which cross from one domain to another.

The resource group identifier may be used to identify any number of resources on a pre-configured network path and the resources may be limited to those belonging to a predetermined network domain and may comprise all of the resources of that network domain on the pre-configured network path or a subgroup of resources within that network domain.

In one embodiment, the resource group identifier may be used to identify those resources of a label switched path (LSP) in which the resources may or may not be limited to a predetermined network domain.

In one embodiment, the method further comprises the step of including in the signal, an instruction associated with the resource group identifier for causing a network element to process the resource group identifier based on the instruction. For example, the instruction may comprise an instruction to either include or exclude a resource group indicated by the group identifier in configuring a communication path, and the signal may comprise a set-up signal for configuring a communication path through a network.

According to another aspect of the present invention, there is provided a method of forming a signal for transmission on a network, comprising the steps of: receiving a resource group identifier used to identify one or more resources on the network, identifying from a record a resource identifier of one or more resources associated with the group identifier, and forming a signal containing a resource identifier of at least one resource identified from the record.

According to another aspect of the present invention, there is provided a network element comprising: receiving means for receiving a signal containing a resource group identifier used to identify a group of resources on a pre-configured network path, and signal forming means arranged to form a signal for transmission on the network, the signal containing the resource group identifier.

According to another aspect of the present invention, there is provided a network element comprising: receiving means for receiving a signal containing a resource group identifier used to identify one or more resources on a network, storage means containing a record of the resource group identifier and associated with the resource group identifier a respective resource identifier identifying each of the one or more resources in the group, comparing means for comparing the resource group identifier in the signal to the resource group identifier in the record, and signal forming means responsive to a result of the comparison for forming a signal for configuring a communication path.

In one embodiment, the signal forming means is adapted to include in the signal, an instruction associated with an identifier for causing another network element to make a decision based on the instruction. The instruction may comprise an instruction to include or an instruction to exclude a resource when configuring the communication path.

The network element may reside in a predetermined network domain, and the receiving means may be adapted to receive the signal containing the resource identifier from another network domain.

In one embodiment, the network element resides in a predetermined network domain and is adapted to transmit the signal for configuring the communication path to another network element in the same predetermined network domain.

The network element may be adapted to transmit to at least one other network element another signal comprising the resource group identifier and a resource group identifier identifying at least one resource associated with the group identifier. The network element and the other network element may both be in the same network domain.

According to another aspect of the present invention, there is provided a network element in a predetermined network domain comprising: storage means for storing a resource group identifier and a resource identifier identifying at least one resource in the network domain associated with the resource group identifier, the number of resources associated with the resource group identifier being fewer than the resources in the network domain, and signal forming means for forming a signal for transmission on a network, the signal containing the resource group identifier and resource identifier identifying at least one resource associated with the resource group identifier, and transmitting means for transmitting the signal to at least one other network element.

The network element may further comprise selection means for selecting at least one other network element based on which other network elements are located in the same network domain as the network element.

In one embodiment, the group identified by the resource group identifier includes fewer than all of the nodes in the network domain. The group identified by the resource group identifier may consist essentially of resources in a predetermined path in the network domain.

In one embodiment, the one or more resources associated with the resource group identifier each comprises a resource to be one of included in and excluded from a communication path.

The resource group identifier may be associated with one or more identifiers for identifying a common property of resources on the network.

According to the present invention, there is further provided a data structure comprising: a resource group identifier identifying a group of resources on a network, and associated with said resource group identifier at least one resource identifier for identifying a resource in said group.

### BRIEF DESCRIPTION OF THE DRAWINGS

Examples of embodiments of the present invention will now be described with reference to the drawings, in which:

FIG. 1 shows an example of a communication network which traverses different domains;

FIG. 2 shows a schematic diagram of a network element (or node) according to an embodiment of the present invention;

FIG. 3 shows a schematic diagram of a network element according to another embodiment of the present invention;

FIG. 4 shows a schematic diagram of part of a set- up signal according to an embodiment of the present invention;

FIG. 5 shows an example of another communication network which traverses different domains;

FIG. 6A shows a network element according to an embodiment of the present invention, and

FIG. 6B shows a network element according to another embodiment of the present invention.

### DESCRIPTION OF EMBODIMENTS

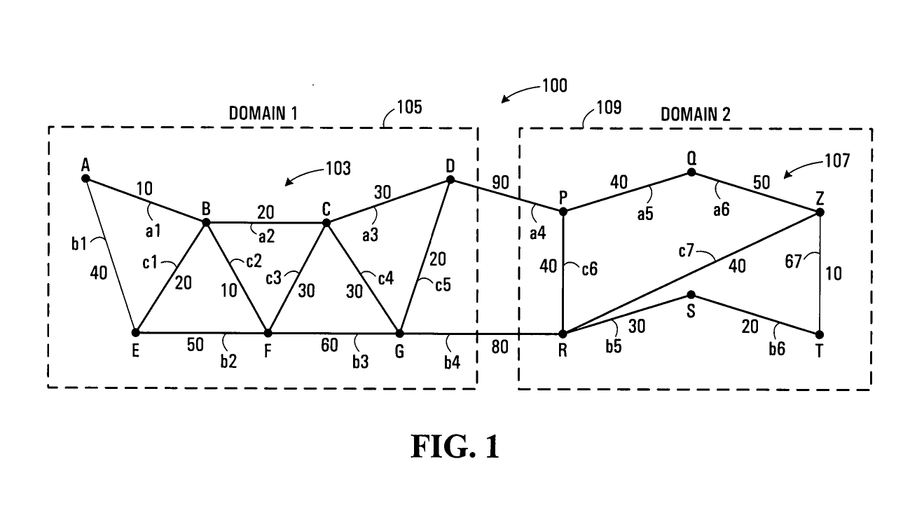

Referring to FIG. 1, a communication network generally shown at 100, includes a first network 103 in a first domain 105 and a second network 107 in a second domain 109, and each network includes a number of nodes and links between the nodes. A primary communication path, for example, a label switched path (LSP), is configured from node A in the first domain 105 to node Z in the second domain 109, for example using “Shortest Path First” or another set-up protocol. In this example, the primary path includes nodes A, B, C, D, P, Q and Z and links a1, a2, a3, a4, a5 and a6. Each link on the primary path is assigned a group identifier, for example, a Shared Risk Link Group (SRLG) identifier, which may, for example, comprise a 32 bit number but which in this example is shown as a two digit ordinary number, for simplicity.

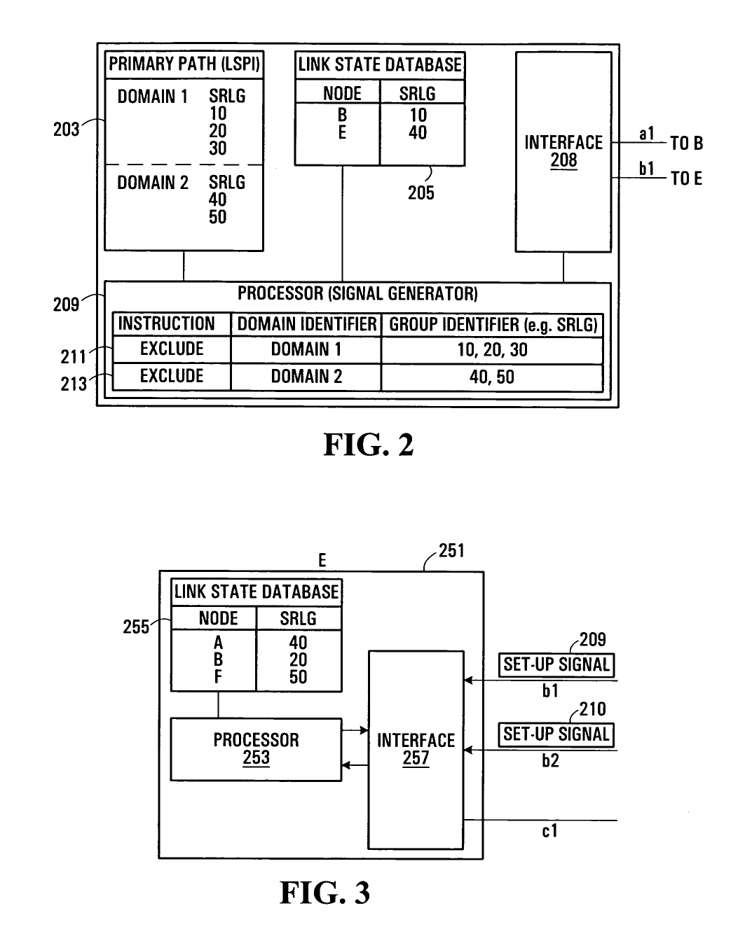

Referring to FIG. 2, which shows a schematic diagram of a network element, once the primary path has been established, the SRLG identifiers of each link on the primary path are recorded in the network element from which the primary path is established, in this case node A. In this embodiment, each SRLG identifier is stored in a table 203 together with an identification of the domain or AS with which the SRLG ID is associated. Thus, the table may be structured to include a plurality of lists of SRLGs each for a different domain. This data may be stored in any suitable memory or other recording medium provided by the network element.

The network element also includes a link state database 205 which includes a list of network elements that are immediately adjacent node A, together with the SRLG identifiers of the associated links.

To set up a secondary path, network element A includes a signal generator (e.g. processor) adapted to generate a set-up signal which includes certain conditions or constraints to be used by network elements in determining the secondary path. The conditions may include a specification of network resources that should be included in and/or excluded from the secondary path. The set-up signal may comprise a data packet (or message) and the specification of each set-up condition may comprise an object in the data packet. Each object may comprise an instruction (e.g. to include or exclude), and one or more sub-objects, e.g. group identifiers to which the instruction relates.

In the example shown in FIG. 2, the network element 201 is adapted to include in the set-up signal 209 an identification of resources that are to be excluded from the secondary path, and in this particular embodiment at least one group identifier. Advantageously, the signal also includes an identification of the domain to which the group identifier belongs so that each node which is involved in setting up the path can determine whether the exclusion(s), e.g. the excluded SRL group(s) applies to the area in which the node resides or not. Generally, if a node determines from the signal that the group identifier belongs to its domain, the node will make a decision regarding which resources to use in setting up the next path section based on the group identifiers. If the node determines that the area associated with the group identifier(s) in the signal is different from that in which the node resides, the node may ignore this portion of the signal.

In the embodiment of FIG. 2, the network element includes in the set-up signal 209 a list of SRLG identifiers of resources on the primary path which are to be excluded when setting up the secondary path, and which may be derived from the table 203. In particular, the signal includes an exclude instruction, and specifies both the group IDs to be excluded and the domain or area to which each group ID belongs. In the embodiment shown in FIG. 2, a section 211 of the signal contains the domain identifier of domain 1 and the group IDs associated with that domain that are used for the primary path, and a section 213 contains a domain identifier for domain 2 and the group identifiers for the primary path in domain 2. This list is used by each node involved in setting up the secondary path to determine which resources must or should be excluded.

In setting up a diverse path, node A is instructed to determine a path which excludes all of the Shared Risk Link Group identifiers of the primary path in domain 1, consults the link state database 205 for a link that meets this condition and transmits the signal to node E over link b1 whose SRLG ID is 40 (i.e. different from any SRLG IDs on the primary path in domain 1). On receiving the signal, node E detects the domain identifier for domain 1 in the signal and the SRLG IDs listed for that domain and makes a path set-up decision based on the conditions prescribed in the signal for domain 1. In this embodiment, the signal indicates that resources having SRLG IDs of 10, 20 and 30 should be excluded, and therefore of possible links b2 and c2, node E selects link B2, whose SRLG ID is 50, as the next path section and which meets the required condition. By specifying in the signal the domain to which specific conditions relate, node E can select from the signal which conditions apply to it and which do not. For example, node E may be adapted to extract from the signal only those conditions that apply to its domain and to ignore conditions that apply to other domains. This may be implemented by conditioning a network element to make a comparison of its record of the domain in which it resides with the domain identifier(s) in the signal. Thus, in the present example, although the primary path includes a link whose SRLG ID is 50, the signal indicates that this SRLG ID is associated with domain 2 and not domain 1 and therefore node E can choose a link having an SRLG ID of 50 to form the secondary path in domain 1.

An embodiment of a network element which may implement the functions described above in connection with node E is shown in FIG. 3. The network element 251 comprises a processor 253, a database 255 and an interface 257 connected to (bi-directional) links b1, b2, c1. The processor is arranged to receive set-up signals transmitted to the network element via the interface 257 and is conditioned (e.g. programmed) to detect network domain identifiers attached to path set-up conditions contained in the signal to determine if the signal contains any set-up conditions which apply to the domain in which the network element resides, and this may be performed by comparing domain identifiers in the signal with a record of the domain identifier of a network element, as indicated above. If a match is found, the processor detects the condition associated with the domain identifier and makes a decision based on the detected condition and the information stored in the link's database 225 as to which resources (e.g. node and/or link) to use in configuring the next path section. The processor is adapted to ignore set-up conditions in the signal that are attached to domain identifiers of domains in which the network element does not reside. Once the processor determines the resources for the next path section, the processor may form an appropriate set-up signal and the network element transmits the set-up signal 210 to the next node on the determined communication path.

Other nodes in the first domain, e.g. nodes F and G use the information in a similar manner to that described above to set up respective sections of the secondary path. In this example, the secondary path includes links b3 and b4 which meet the required conditions, and excludes links c1 to c5, which do not as they have the same SRLG Ids as the primary path.

In this example, nodes D and G are border network elements as they lie on the edge of the first domain and nodes P and R are border network elements of the second domain. The link A4 between nodes D and P in the primary path may have an associated SRLG ID, and to exclude this link from the secondary path, the set-up signal may contain the SRLG ID for this link together with an indication that the link is an interdomain link between domains 1 and 2. As node G is a border NE in domain 1, node G may be adapted to detect the indication of an interdomain condition in the signal and apply the condition to the path set-up process. Accordingly, if the signal indicates that SRLGs having an ID of 90 should be excluded, node G can try to determine a link having a different SRLG ID, e.g. link b4 to node R having an SRLG ID of 80.

On receiving the set-up signal from node G, node R in the second domain is adapted to detect the conditions for setting up the secondary path in domain 2 by detecting the domain ID for domain 2 in the set-up signal. In this way, node R can identify which conditions in the signal apply to it when setting up the next path section. In this example, the signal contains a condition that resources having SRLG IDs of 40 and 50 are to be excluded from the secondary path, and therefore node R selects link b5 to node S having an SRLG ID of 30 as the next section for the secondary path. Other nodes, e.g., S, and T in the second domain respond to the set-up signal in a similar manner to exclude from the secondary path links a5 and a6 of the primary path having SRLG IDs of 40 and 50, respectively, and also links c6 and c7 which both have an SRLG ID of 40.

As can be appreciated from the example described above in conjunction with FIGS. 1 and 2, specifying both the conditions and the domain ID to which the conditions relate in the set-up signal allows the conditions to be properly implemented when setting up a communication path between different domains, and may be applied when setting up any communication path, including a primary communication path or a secondary communication path, where certain path set-up conditions are to be met. A domain ID may be included in a set-up signal in addition to the group identifier(s) even if the path to be configured traverses a single domain, and may be useful as a verification check.

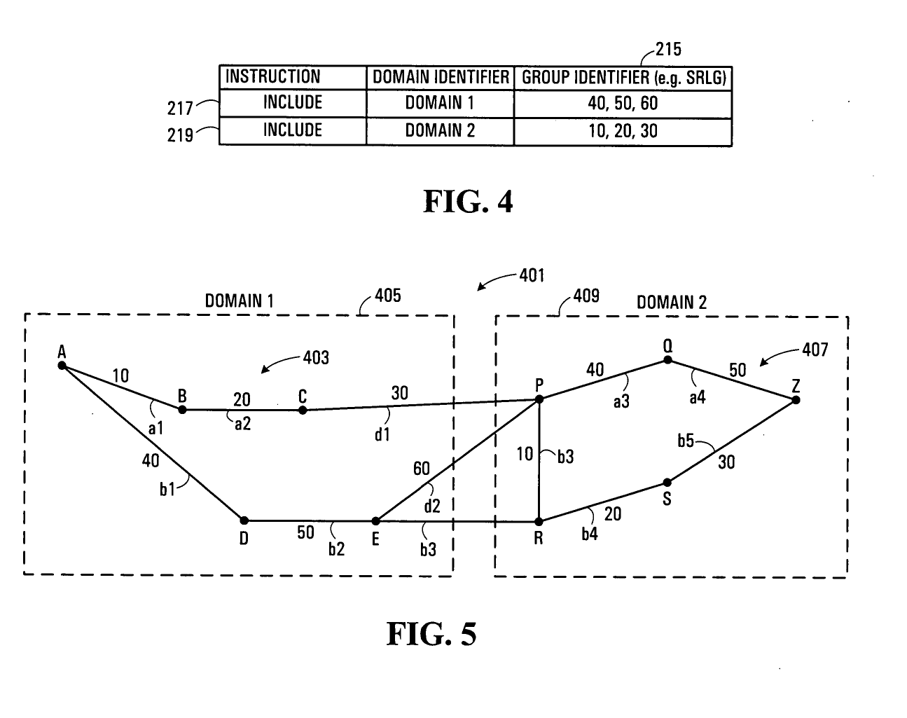

In other embodiments, the set-up signal may include a specification of resources that are to be specifically included in a particular communication path and the signal may indicate for each domain, the particular set of conditions to be implemented, together with an identification of the particular domain to which the conditions relate. Thus, in another embodiment, the set-up signal for configuring a secondary path may include particular SRLG IDs that are to be included in the secondary path, and may or may not also include certain SRLGs that are to be excluded. Returning to the example of FIG. 1, and referring to FIG. 4, in setting up the secondary path, the set-up signal 215 may include a specification 217 that resources having SRLG IDs of 40, 50 and 60 in domain 1 are to be specifically included in the secondary path and a specification 219 that resources having SRLG IDs of 10, 20 and 30 are to be specifically included in the secondary path in domain 2. This implementation may be used as an alternative or in addition to the exclusion instructions shown in FIG. 2, and would also lead to the desired result of excluding primary path resources from the secondary path.

The set-up packet(s) may have any suitable configuration, depending on the system protocol. For example, the set-up signal may be constructed so that the domain identifier associated with the condition is detected by the network element processor before the condition, so that the processor can determine first if the condition is applicable to its path set-up decision. The examples shown in FIGS. 2 and 3, in which the instruction is indicated first and the domain identifier second, is not necessarily indicative of the order in which they would be placed in a data packet, and in another embodiment, the domain identifier may be placed before the instruction.

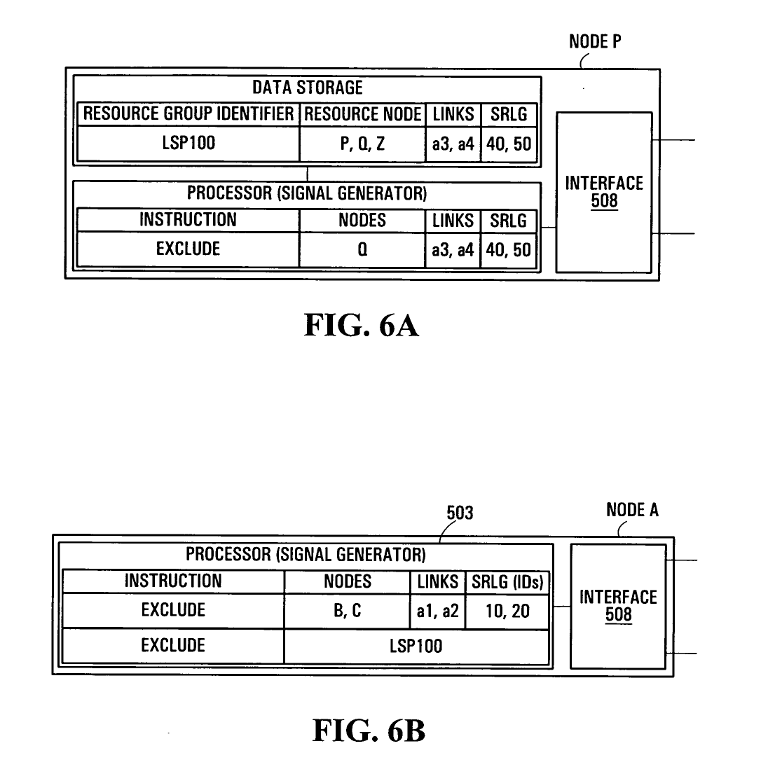

Another aspect of the present invention allows the information content of communication path set-up signals to be reduced. An embodiment of this aspect of the present invention is described below with reference to FIGS. 5, 6A and 6B. FIG. 5 shows a communication network 401 comprising a first network 403 in a first domain 405 and a second network 407 in a second domain 409. A primary communication path is established between node A in the first domain and node Z in the second domain and includes nodes A, B, C, P, Q and Z, and links a1, a2, d1, a3 and a4. Node P is a border PE (Peer Element) of the second domain 409 and is adapted to store information about the resources in domain 2 used for the primary path. This may include an identification of the nodes, links and/or SRLG identifiers associated with the links. A label or identifier is assigned to this information (for example by node P), as an alternative means or alias by which the information can be referred. The identifier generally identifies a group of one or more network resources (e.g. nodes, ports, links) or sub-groups of resources (e.g. SRLG ID's) and may be referred to as a resource group identifier. In the example shown in FIG. 5A, the resource group identified by the resource group identifier LSP100 includes resources on the primary path in domain 2, and the record 501 stored at node P includes a data structure comprising the resource group identifier and resource identifiers identifying the resources in the group. In one embodiment, the data structure may comprise a lookup table.

The resource group identifier is transmitted to the node from which the path is to be set-up, in this case node A and used by node A to generate signalling to determine a secondary path between nodes A and Z. Referring to FIG. 6B, node A generates a set-up signal 502 which includes a list 503 of primary path resources that should be excluded in configuring the secondary path. The list 503 may, for example, comprise an Exclude Route Object (XRO) in a RSVP-TE set-up signal. In this particular embodiment, the list includes nodes B and C, links a1 and a2 and the SRLG identifiers 10, 20 for links a1 and a2 respectively. In addition, the list also specifies the resource group identifier, in this case is LSP100, which is used to identify the primary path resources in the second domain. Using a resource group identifier to identify domain 2 primary path resources in the set-up signal that traverses domain 1 serves two purposes. Firstly, as the group identifier can be shorter than a list of all individual resource identifiers in the group, it reduces the set-up signal overhead by reducing the space required to specify the primary path resources of domain 2, and secondly it prevents the domain 2 primary path resources being revealed to other domain resources such as network elements in domain 1.

In a first embodiment, the set-up signal specifies that the secondary path must include border network element P, and this may be implemented in the signal by specifying node P as an object in an Include list (not shown).

In setting up the first leg or hop of the secondary path, node A is instructed to select a node other than node B and/or a link other than link al and a resource having an SRLG ID other than 10. In this example, node A selects node D and transmits the set-up signal to node D over link bl having an SRLG ID of 40. An area or domain identifier identifying domain 1 may optionally be included in the set-up signal to indicate that domain 1 objects in the exclude list are associated with domain 1.

On receiving the set-up signal from node A, node D determines from the exclude list resources to be excluded from the secondary path and selects node E over link b2 as the next path section. Node D is also adapted to ignore the resource group identifier LSP100, since, for example, it has no record of the identifier and cannot attribute any meaning to it.

On receiving the set-up signal from node D, node E determines from the set-up signal (which in this embodiment includes a specification that the secondary path must include node P) that the next section of the secondary path is to node P over link d2. Again, node E is adapted to ignore the path resource label LSP100.

In one embodiment, one or more nodes in the first domain may be adapted to remove objects from the exclude list when a determination is made that they are no longer required. This has the advantage of reducing signal overhead and only passing information in the set-up signal that is required for downstream nodes or interfaces. For example, in one embodiment, a node in one domain that determines the next path section to a node (e.g. border PE) in another domain may be adapted to remove at least one or more objects from the exclude and/or include lists to prevent resource information about one domain passing to another domain. Thus, for example, node E may be adapted to strip resource information pertaining to domain 1 from the exclude list 503. In this case, the set-up signal transmitted from node E to node P may include as an exclude object only the resource group identifier LSP100 (and possibly other resource group identifiers for other domains, for example, if the path is to extend beyond node Z to a node in another domain). Other nodes, upstream of the border PE may also implement a stripping function to reduce the information contained in the set-up signal. For example, node D may be adapted to remove certain information from the exclude list for domain 1 which is no longer required, such as information relating to the first section of the primary path (e.g. node B, link a1 and SRLG ID's 10).

On receiving the set-up signal from node E, node P detects the resource group identifier LSP100 and determines from its record 501 the resources in domain 2 that are associated with this identifier. This may be carried out by performing a lookup function in a lookup table stored in a memory at node P. In one embodiment, node P generates a set-up signal which specifies the particular resources that are to be excluded when forming a secondary path through domain 2 (to avoid resources of the primary path) and which may be included in an exclude list.

In this example, the set-up signal generated by node P includes an exclude list 505, shown in FIG. 6B, which contains node Q, links a3, a4 and SRLG ID's 40 and 50. In computing the first path section of the secondary path in domain 2, node P is instructed to exclude node Q and selects (for example, from its link state database (not shown)) node R over link b3 as the first path section.

On receiving the set-up signal from node P, node R detects the resources in the excludes list to be excluded from the secondary path and selects node S over link b4 as the next path section. Similarly, on receiving the set-up signal from node R, node S reads the resource identifiers in the exclude list and determines node Z over link b5 as the next, and in this case last, secondary path section.

In the example described above, the secondary path includes a resource of the primary path, i.e. node P, and this potentially constitutes a weakness in the secondary path as alternative routing between nodes A and Z. Another embodiment of the present invention enables resource group identifiers to be used without needing to route the secondary path through a primary path node. This may be achieved by advertising the resource group identifier and the resources associated therewith to one or more other nodes within the same domain, for example one or more other border PE's. Returning to the example shown in FIG. 4, node P may be adapted to advertise the resource group identifier and resources associated therewith to node R which also constitutes a border PE. Node R records this information and is adapted to respond to a set-up signal containing the resource group identifier. Node P may also advertise the path group identifier to one or more other border PE's in domain 2 to increase the number of the border PE's in domain 2 through which the secondary path can be formed.

Returning to the example described above, the set-up signal generated at node A may be adapted to specify that node P should be excluded from the secondary path (rather than specifically included, as in the first example). On receiving the set-up signal from node D, node E determines that node P should be excluded from the secondary path and selects an alternative border PE in domain 2, and in this case selects node R over link b3 as the next path section. Node E transmits a set-up signal, which includes the resource group identifier LSP100, to node R, and which may omit information about resources in domain 1, as described above. On receiving the set-up signal from node E, node R detects the resource group identifier in the signal, compares the detected resource group identifier to a record of resource group identifier(s) stored at node R, and on finding a match, determines the domain 2 resources that are to be excluded when forming the secondary path. Node R then generates a set-up signal which may specify the specific resources to be excluded from the secondary path, as, for example, described above for node P. In this case the set-up signal may include the resource identifiers for nodes P and Q, links a3 and a4 and SRLG IDs 40, 50.

Alternatively, if node P is adapted to advertise the resource group identifier and resources associated therewith to a number of nodes or all nodes in the second domain, so that a number of nodes or all nodes in domain 2 have a record of both the resource group identifier and resources associated therewith, the set-up signal for determining a path in the second domain need only include the resource group identifier, thereby reducing set-up signal overhead.

In another embodiment, the primary path border PE in the second domain may be adapted to advertise the resource group identifier to a restricted number of nodes, e.g. border PE's within its domain. In setting up the secondary path, the set-up signal from one domain may initially be passed to the same border PE of the primary path in another domain. This border PE may signal back to a node in the first domain (e.g. egress node) the identity of another border PE in the second domain to be used for the secondary path. To illustrate this, reference may be had to the example in FIG. 5. In this case, the initial set-up signal from node A includes an instruction to consult node P when forming the secondary path. When node P receives the set-up signal from node E, it responds by identifying one or more alternative border PE's in the second domain through which the secondary path can be routed and transmits this information back to node E. Node E determines from the signal a border PE in the second domain other than node P to which to configure the next path section, and, in this example, selects node R as the border PE and transmits the set-up signal to node R over link b3. Again, in forming the set-up signal, node E may remove information about resources in the first domain so that this information is not transmitted into the second domain.

Advantageously, this arrangement in which only selected border PE's receive the resource group identifier and an identification of the resources associated therewith reduces the amount of information that needs to be stored by nodes in the second domain thereby improving the scalability of the system.

Embodiments of the invention have been described by way of non-limiting examples only to illustrate the principles of various aspects of the invention, and it will be appreciated that the principles of the invention can be applied to any suitable network and to configuring any communication path whether it traverses a single domain or any number of different domains.

For example, in one embodiment, a resource group identifier may be used to identify a group of resources in the first domain which contains the source node from which the path is to be set-up. This resource group identifier may be used in the set-up signalling to obviate the need to explicitly identify the particular resources in the first domain that should be included or excluded when forming a path. However, this embodiment assumes that nodes in the first domain have the capability of interpreting the resource group identifier, and therefore assumes some prior signalling to each node such as an advertisement from the source node to provide this capability.

In other embodiments set-up signalling from the source node may include resource group identifiers for a plurality of different domains and which can only be correctly interpreted by one or more nodes in the relevant domains. Once it is determined that information about resources in a particular domain in the set-up signal is no longer required the information may be stripped from the set-up signal before being passed to the next domain, if any, to simplify the set-up signal and to ensure resource information about one domain is not revealed to another.

Other embodiments of the present invention may include any feature disclosed herein in combination with any one or more other feature disclosed herein.

Modifications to the embodiments described herein will be apparent to those skilled in the art.

1. A method of forming a signal for configuring a communication path comprising:
selecting at least one identifier used to identify one or more network resources in a predetermined network domain; and
forming a signal for causing one or more network elements to configure a communication path including specifying in said signal said at least one identifier and a network domain identifier which indicates that said at least one identifier is associated with said network domain.

2. A method as claimed in claim 1, wherein said at least one identifier comprises a group identifier used to identify said one or more resources.

3. A method as claimed in claim 2, wherein said at least one group identifier is used to identify a plurality of network resources in said predetermined network domain having a common property.

4. A method as claimed in claim 1, further comprising specifying in said signal an indication that network resources in said domain having said at least one identifier should be one of included and excluded in configuring said communication path.

5. A method as claimed in claim 1, further comprising selecting one or more identifiers used to identify one or more network resources in another predetermined network domain; and
specifying in said signal said one or more identifiers and a network domain identifier for said other network domain which indicates that said one or more identifiers is associated with said other predetermined network domain.

6. A method as claimed in claim 1, wherein at least one of (1) said network resources comprise communication path sections, and (2) said group identifier comprises a shared risk link group (SRLG) identifier.

7. A method of determining a communication path comprising the steps of:
receiving a communication signal containing at least one identifier used to identify one or more network resources and an indication that said at least one group identifier is associated with a predetermined network domain;
detecting the indication of said network domain in said signal;
based on the detected network domain, determining whether to include said at least one identifier in a decision on determining said communication path; and
determining said communication path.

8. A method as claimed in claim 7, wherein said at least one identifier comprises a group identifier used to identify said one or more network resources.

9. A method as claimed in claim 8, further comprising determining whether to include or exclude from said communication path network resources associated with said at least one group identifier if said detected network domain is the same as that of said at least one network element.

10. A method as claimed in claim 8, further comprising excluding from consideration in determining said communication path network resources having any group identifiers associated with a detected network domain in said signal if the detected domain is different from that of said at least one network element.

11. A network element comprising signal forming means for forming, for transmission on a network, a signal for configuring a communication path,
wherein said signal forming means is adapted to included in said signal at least one identifier used to identify one or more network resources in a predetermined network domain, and
a network domain identifier indicating that said at least one identifier is associated with said network domain.

12. A network element as claimed in claim 11, wherein said at least one identifier comprises a group identifier used to identify said one or more network resources.

13. A network element as claimed in claim 12, wherein said signal forming means is adapted to specify in said signal an indication that network resources in said domain having said at least one group identifier should be one of included and excluded in configuring said communication path.

14. A network element as claimed in claim 13, wherein said signal forming means is adapted to specify in said signal one or more further group identifiers, each further identifier used to identify network resources in another predetermined network domain, and to specify in said signal an identifier for said other network domain indicating that said one or more group identifiers is associated with said other predetermined network domain.

15. A network element comprising receiving means for receiving a communication signal containing at least one group identifier used to identify one or more network resources and an indication that said at least one identifier is associated with a predetermined network domain,
detecting means for detecting the indication of said network domain in said signal,
first determining means for determining, based on the detected network domain, whether to include said at least one identifier in a decision on configuring a communication path; and
second determining means for determining said communication path.

16. A network element as claimed in claim 15, wherein said at least one identifier comprises a group identifier used to identify said one or more network resources.

17. A network element as claimed in claim 16, wherein said second determining means is adapted to determine whether to include or exclude from said communication path network resources associated with said at least one group identifier if said detected network domain is the same as that of said network element.

18. A method of forming a signal for transmission on a network, comprising receiving a resource group identifier used to identify a group of resources on a pre-configured network path, and forming a signal containing said resource group identifier.

19. A method as claimed in claim 18, further comprising the step of including in said signal an instruction indicator associated with said resource group identifier for causing a network element to process said resource group identifier based on said instruction indicator.

20. A method as claimed in claim 19, wherein said instruction indicator indicates an instruction to one of include and exclude a resource of the group indicated by said group identifier in configuring a communication path.

21. A method as claimed in claim 18, wherein said signal comprises a set-up signal for configuring a communication path through a network.

22. A method as claimed in claim 18, further comprising the step of selecting one or more resources, and assigning said resource group identifier to said one or more resources.

23. A method as claimed in claim 18, wherein at least one of (1) said resource group identifier is assigned only to resources in the same predetermined network domain, and (2) each selected resource comprises a resource of a predetermined communication path.

24. A method as claimed in claim 18, wherein one of (1) the step of receiving comprises receiving said resource group identifier at a network element in one network domain from another network element in another network domain, and (2) the step of receiving comprises receiving said group identifier at a network element from a record containing said resource group identifier in the same network element.

25. A method of forming a signal for transmission on a network, comprising the steps of:
receiving a resource group identifier used to identify one or more resources on the network, identifying from a record a resource identifier of one or more resources associated with said group identifier, and forming a signal containing a resource identifier of at least one resource identified from said record.

26. A method as claimed in claim 25, further comprising including in said signal an instruction associated with said resource identifier for causing a network element to make a decision based on said instruction and the resource identified in said signal.

27. A method a claimed in claim 25, wherein each resource comprises a resource within the same domain.

28. A network element comprising:
receiving means for receiving a signal containing a resource group identifier used to identify a group of resources on a pre-configured network path, and signal forming means arranged to form a signal for transmission on said network, said signal containing said resource group identifier.

29. A network element as claimed in claim 28, wherein at least one of (1) said signal comprises a signal for configuring a communication path on the network, and (2) said network element resides in a predetermined network domain and said resource group identifier is associated with one or more resources in another network domain.

30. A network element comprising:
receiving means for receiving a signal containing a resource group identifier used to identify one or more resources on a network,
storage means containing a record of said resource group identifier and associated with said resource group identifier a respective resource identifier identifying each of said one or more resources in said group,
comparing means for comparing the resource group identifier in said signal to said resource group identifier in said record, and
signal forming means responsive to a result of the comparison for forming a signal for configuring a communication path.

31. A network element as claimed in claim 30, wherein said signal forming means is adapted to include in said signal at least one of said resource group identifier and a resource identifier of at least one resource associated with said resource group identifier.
